(19) United States
(12) Patent Application Publication
(10) Pub. No.: US 2005/0039028 A1
(43) Pub. Date: Feb. 17, 2005

(54) E-mail security system

(76) Inventor: Wendy Eason, Decatur, GA (US)

Correspondence Address: MERCHANT & GOULD PC, P.O. BOX 2903, MINNEAPOLIS, MN, 55402-0903, US

(21) Appl. No.: 10/626,461

(22) Filed: Jul. 24, 2003

(51) Int. Cl. H04L 9/32

(52) U.S. Cl. 713/187

(57) ABSTRACT

E-mail security systems are provided. A representative system, among others, includes an e-mail client. A representative e-mail client, among others, includes a message composition logic and a write protect logic. The message composition logic is operable to compose a message to at least one recipient, and the write protect logic is operable to protect the message against subsequent alteration by said at least one recipient. Methods and other systems for e-mail security are also provided.

### FIELD OF THE INVENTION

The present invention is generally related to communications, and more particularly related to security of e-mail messages.

### DESCRIPTION OF THE RELATED ART

The use of electronic mail, more commonly referred to as e-mail, has grown exponentially since its conception. Once relegated to a novel toy for university researchers, e-mail has grown to be used by an ever expanding array of business and industry. Just as researchers use it to keep colleagues apprised of the latest developments, business executives use it to keep in constant touch with events that affect their dealings. Moreover, e-mail is used by employees at all levels to, for example, request a purchase, confirm appointments, and communicate important information to the decision makers who require the information. With this increased use comes increasing reliance upon the accuracy and reliability of e-mail correspondence and upon the security of the e-mail client itself.

For reference, a couple of the most common e-mail clients currently used are Outlook, available from Microsoft Corp., of Redmond, Wash., and Eudora, available from QualComm Inc., of San Diego, Calif. These programs can typically include ways to encrypt content and can include a digital signature associated with a sender. However, there remains no way of easily ensuring the continuing accuracy of the content of a particular message. Recipients of an original message can alter the text of a message, either intentionally or accidentally, and forward the message to a third party who is unaware that the original message was altered by the person forwarding the message. Thus, there is a need for systems that overcome the above stated shortcomings, among others.

### SUMMARY OF THE INVENTION

One embodiment, among others, of the present invention provides an e-mail client. A representative e-mail client, among others, includes message composition logic and write protect logic. The message composition logic is operable to help compose a message to at least one recipient, and the write protect logic is operable to help protect the message against subsequent alteration by said at least one recipient.

One embodiment, among others, of the present invention provides methods of protecting e-mail. A representative method, among others, can include the following steps: enabling a user to draft a message; and, converting the message into a write-protected format such that recipients are inhibited from altering the content.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram of an embodiment, among others, of an e-mail architecture used to transfer e-mail between client computers.

FIG. 2A is a block diagram of an embodiment, among others, of the client computers of FIG. 1, including the e-mail client of the present invention.

FIG. 2B is a block diagram of an embodiment, among others, of the client computers of FIG. 1, illustrating some components of the e-mail client.

FIG. 3 is an illustration of an embodiment, among others, of a screen shot of a mailbox display of the e-mail client of FIG. 2B.

FIG. 4 is an illustration of an embodiment, among others, of a screen shot of an e-mail composition display of the e-mail client of FIG. 2B.

FIG. 5A is a block diagram of an embodiment, among others, of the ISP server and client computers of FIG. 1, including a web browser that can be used in conjunction with the e-mail client of the present invention.

FIG. 5B is a block diagram of an embodiment, among others, of the ISP server and client computers of FIG. 1, illustrating an e-mail client on the ISP server not shown in FIG. 5A.

FIG. 6 is an illustration of an embodiment, among others, of a screen shot of an message center web page of the e-mail client of FIG. 5B.

FIG. 7 is an illustration of an embodiment, among others, of a screen shot of an e-mail composition web page of the e-mail client of FIG. 5B.

FIG. 8 is a flowchart of an embodiment, among others, illustrating the operation of the e-mail client of FIGS. 2B and 5B.

### DETAILED DESCRIPTION OF THE PREFERRED EMBODIMENTS

The preferred embodiments of the present invention now will be described more fully with reference to the accompanying drawings. The invention may, however, be embodied in many different forms and should not be construed as limited to the embodiments set forth herein; rather, these embodiments are intended to convey the scope of the invention to those skilled in the art. Furthermore, all “examples” given herein are intended to be non-limiting.

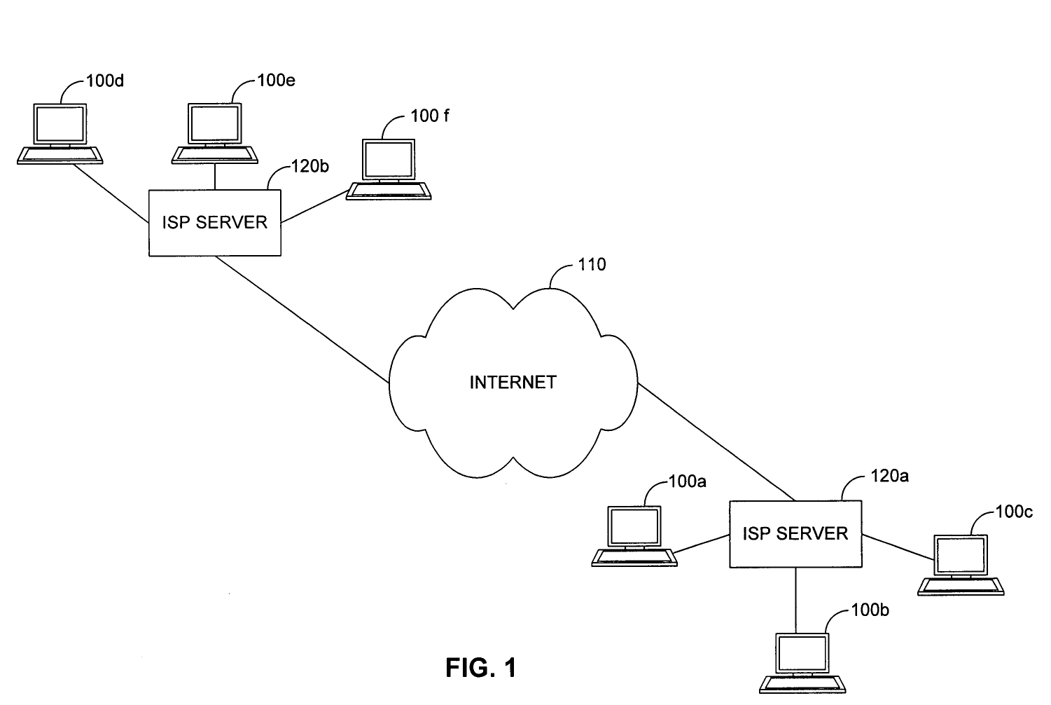

Referring now to FIG. 1, shown is a block diagram illustrating an architecture used for e-mail transport and delivery used in one embodiment, among others, of the present invention. Each of a plurality of remote computers 100a-f access the internet 110 (or other network) through a local internet service provider (ISP) server 120a, 120b (or other gateway systems). It should be recognized by one skilled in the art that the ISP server 120a, 120b can offer a user access to the internet 110 through a plethora of connection types, including a digital subscriber line (DSL) service, an integrated services digital network (ISDN) service, an analog dial-up service, ethernet, T-1, or any other service for transmitting data between devices. Each of the ISP servers 120a, 120b, in turn, are connected to the internet 110. This internet connectivity enables the ISP servers 120a, 120b and other servers connected to the internet to transfer information amongst the servers 120a, 120b using various universal protocols recognized by the servers.

With specific regard to e-mail, the ISP servers 120a, 120b generally include both a post office protocol 3 (POP3) server and a simple mail transfer protocol (SMTP) server with a multi-purpose internet mail extension (MIME). Typically, the e-mail client on computers 100a-f include a POP3 component and an SMTP component with MIME encapsulation for non-ASCII (American Standard Code for Information Interchange) attachments. The SMTP component on a computer 100a-c will transfer an e-mail message in the SMTP format to the SMTP server residing on an ISP server 120a. The SMTP server then transfers it to the correct ISP server 120b where it is stored on the POP3 server. Alternatively, one skilled in the art should recognize that acceptable alternatives exist for various elements, e.g., the POP3 server can be replaced by an internet message access protocol 4 (IMAP4) server which can perform all of the POP3 functions and features additional functions for flexibility and efficiency, etc. As mentioned before, the computers 100a-f each have an e-mail client that includes a POP3 component. The POP3 component on the computer 100d-f can contact the POP3 server on the local ISP server 120b and retrieve messages for the user logged in to the client on the respective computer 100d-f.

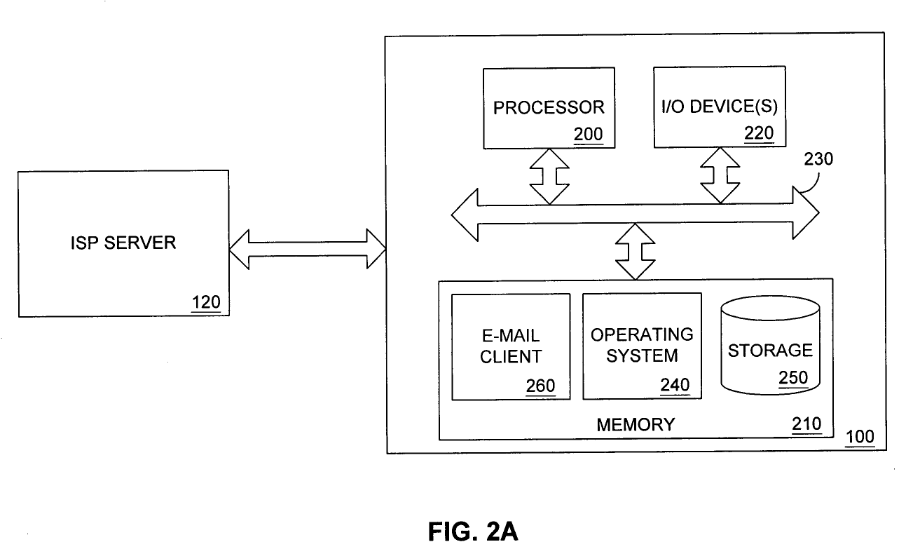

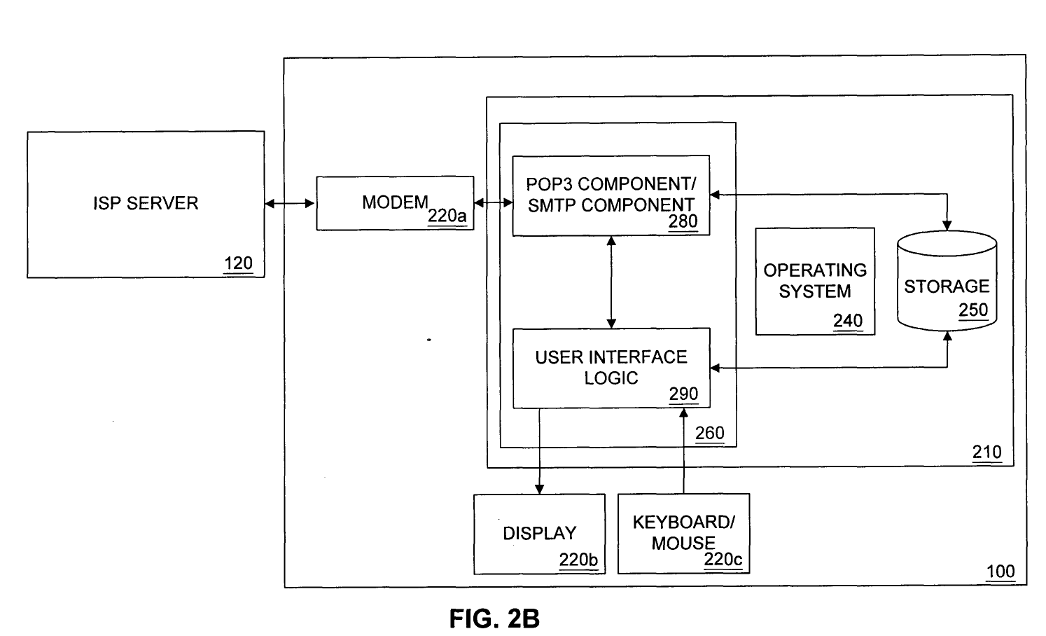

Referring now to FIG. 2A, shown is block diagram of an embodiment of a computer system in accordance with the present invention. As known to those skilled in the art, a computer system typically includes a processor 200, memory 210 and input/output (I/O) device(s) 220, all communicating over a bus 230. The memory typically includes the operating system 240 and non-volatile storage 250. The operating system is typically stored in non-volatile memory while the computer 100 is turned off, and loaded into volatile memory upon start-up, where it can be executed by the processor 200. In the present embodiment, the memory further includes an e-mail client 260 which enables the computer to send/receive e-mail messages to/from the ISP server 120 through an I/O device 220 such as an analog modem, DSL modem, ISDN modem or ethernet card, among others. The e-mail client 260, as discussed above, typically includes a retrieval component (such as POP3) to receive e-mail, a transfer component (such as SMTP) to send e-mail, and some sort of user interface logic to format the output to provide a display that can be understood by the computer user.

Referring now to FIG. 2B, shown is a more detailed diagram of the e-mail client 260 of FIG. 2A. As mentioned above, the e-mail client includes POP3 and SMTP components 280. As one skilled in the art will recognize these protocols merely relate to retrieving and sending e-mail. As such, it is intended that other protocols which operate to send and retrieve e-mail, such as IMAP4, among others, are intended to be included herein. The POP3 component 280 in this embodiment typically downloads e-mail from the ISP server 120 through an I/O modem device 220a, and stores the e-mail in non-volatile storage 250. Moreover, the POP3 server can be set up to retrieve messages for more than one e-mail account.

User interface logic 290 included within the e-mail client 260 can retrieve the messages from the non-volatile storage, format the information, and send the formatted information to the I/O display device 220b. User interface logic 290 can also be configured to display summary information from each of the mailboxes, such as how many messages are contained in each of the subfolders of the mailboxes. One skilled in the art will recognize that in practice, user interface logic 290 typically calls various functions within the operating system that are relayed through the processor 200 (FIG. 2A) before being sent to the display device 220b.

When a user chooses to read a message, the user merely uses an input device 220c to select a message from the active folder. Once selected, a “read” window will open, enabling the user to read the text associated with the selected message. Upon a user choosing to write a new e-mail, reply to an e-mail, or forward an e-mail, user interface logic 290 in one embodiment, among others, of the present invention will open a “write” window that will enable the user to compose a message. Moreover, user interface logic 290, upon opening the window, will stamp the message with the currently active mailbox, or alternatively, could stamp a reply from the e-mail address at which it was received. One skilled in the art will understand that the user typically inputs the e-mail on an I/O device 220c such as a keyboard or mouse. Moreover, one skilled in the art will recognize other input devices on which text and commands can be input, such as voice recognition software, and each of the alternative input devices are intended to be included within the scope of this invention. Upon completion of the e-mail, the user can instruct the e-mail client to send the e-mail. User interface logic 290 will send the message to non-volatile storage 250, if the user has set up the option to save sent messages, and transfer the message to the SMTP component 280. The SMTP component 280 will then transfer e-mail to the ISP server 120 over the modem 220a, if the computer is on-line. If the computer is not on-line the SMTP component 280 will send the message to be stored in non-volatile storage 250 pending being sent the next time the computer is connected to the ISP server 120. As known to those skilled in the art, there are many different ways to facilitate reading and writing a message, and the invention presented herein should not be limited to a particular method for displaying the text of a message or for composing a message.

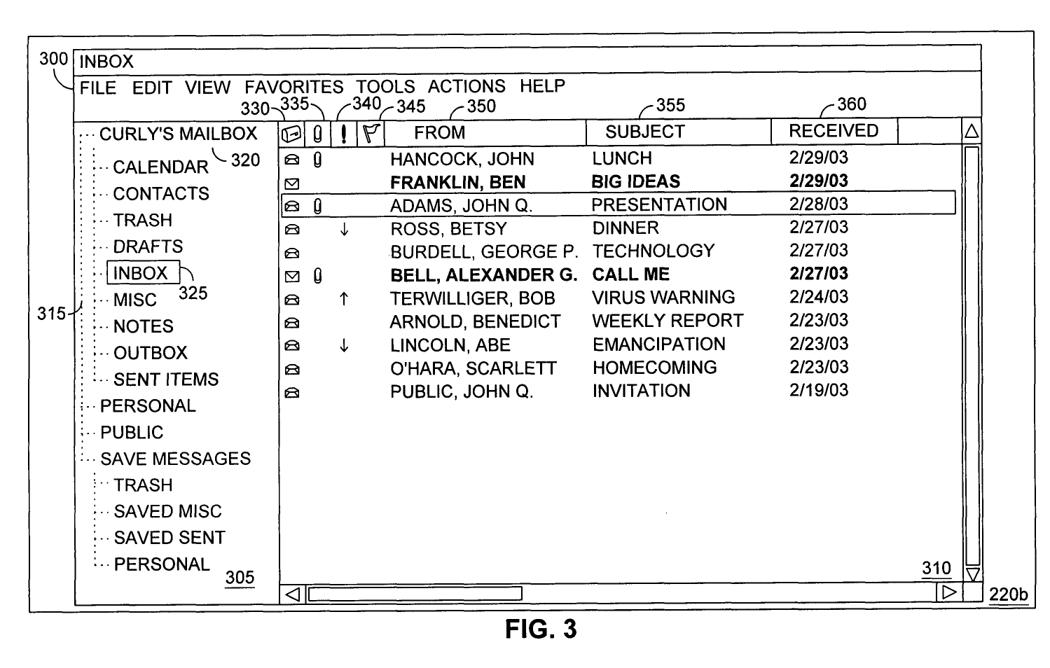

Referring now to FIG. 3, shown is an example, among others, of an illustration of a screen shot of an e-mail client of FIG. 2B. The e-mail client screen typically includes a menu tree representation 300, a folder pane 305, and a current folder message summary pane 310. Typically, the menu tree representation 300 includes a “file” menu representation, an “edit” menu representation, a “view” menu representation, a “favorites” menu representation, a “tools” menu representation, an “actions” menu representation, and a “help” menu representation. Each of these menu representations, when selected, will lead to further options related to the label of the menu representation. For example, selecting the “file” menu representation could pull down a menu from the “file” menu representation that included an option representation to create a new file, open a file, save a file, print a file, or exit the program, among many others.

The folder pane 305 typically includes a file tree 315. The file tree 315, as known to those skilled in the art, can typically be expanded or collapsed by the user, and contains a plurality of folder representations for the user to navigate his or her various folders. The top folder representation 320 in the file tree 315 is typically named for the particular user logged into the system. The folder representations can include, among others: a calendar, contacts, trash, drafts, inbox, miscellaneous, notes, outbox and sent items. Moreover, the client can include other top level folder representations, such as, for example, but not limited to, personal, public, and save messages. The user can typically highlight 325 any of the folder representations in order to select that folder. Here the inbox is highlighted 325, so the inbox content will be summarized in the current folder message summary pane 310.

The current folder message summary pane 310 typically include a plurality of column header representations. The column header representations can typically include, among others: a read status indication 330, an attachment representation 335, a importance level indication 340, a flag for action representation 345, a from field 350, a subject 355, and a date received 360. Each of a plurality of messages are then typically located below the column headers, with their respective information organized into the proper column. Moreover, the messages can typically be arranged in the order of any of the column headers by selecting a particular column header. A second click typically reverses the order of organization. A message can be selected by highlighting 365 the message and selecting the highlighted message. Typically this action will produce a read screen where the user is free to read the selected message. One skilled in the art should recognize that there are a plethora of options upon which the display can arranged, and that this invention is not intended to be limited to a single arrangement.

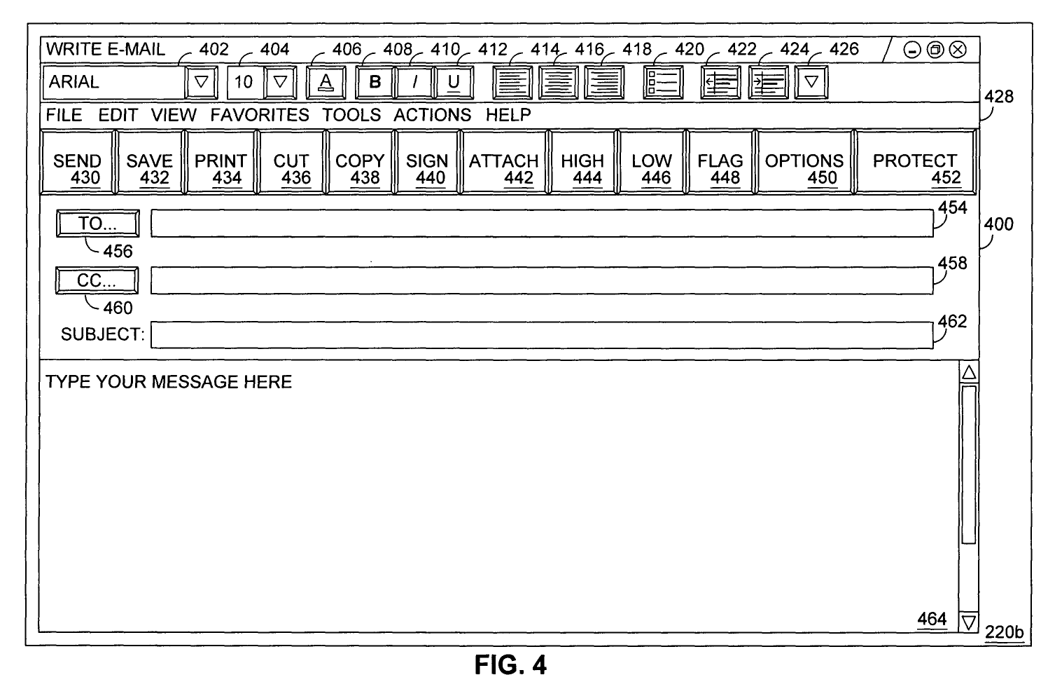

Referring now to FIG. 4, shown is an embodiment, among others, of an illustration of a screen shot of the e-mail client of FIG. 3. One skilled in the art should recognize that this screen is typically accessed by choosing to create a new message or choosing to reply or forward a message stored in one of the mailbox folders. Many of the features of the write e-mail window 400 should be known to those skilled in the art, however, for clarity, brief descriptions of many of these functions will be included.

The write mail window typically will include a list of type-set options that can be applied to the message text. One such option is the font type button representation 402, which allows the user to either type a desired font type in, or select the font from a pull-down list. Related to the font type is the font size button representation 404, which allows the user to select a size for the font. The user can also select a color for the font using the font color button representation 406. The font may also be made bold, italic or underlined using the bold font button representation 408, the italic font button representation 410, or the underline font button representation 412, respectively. With regard to the paragraph settings, the user may use the left justify button representation 414, centered button representation 416, or the right justify button representation 418 to set the current paragraph to left justify, centered, or right justify, respectively. The bullet button representation 420 can be used to create bullet points within the message. The decrease indent button representation 422 can be used to decrease the indentation used for the current paragraph. Similarly, the increase indent button 424 can be used to increase the indentation used for the current paragraph. Button representation 426 can be used to pull down other options that can be included with the write window.

A menu tree representation is typically included in the write window 400. The menu tree is similar to the menu tree seen with respect to FIG. 3. The main menu tree categories are typically the same as the previous menu tree, however, the subcategories of each category can typically include some different choices, as well as many choices that are the same.

The write window 400 also typically includes a plurality of button representations that operate to send instructions to the e-mail client. One typical button representation is the “send” button representation 430. The send button representation typically operates to instruct the e-mail client to send the message and close the write window 400. Another button representation that can be included is the “save” button representation 432. The “save” button representation 432 operates to save the current message, typically in the draft folder of FIG. 3, for future use. The “print” button representation 434 operates to print the current message. The “cut” button representation 436 typically operates to cut the currently selected portion of the message. The “copy” button representation 438 typically operates to copy the current selection for use elsewhere in the operating system environment. The “sign” button representation 440 is typically used to apply a signature to the end of the message. The “attach” button representation 442 is typically used to attach a file to the message typically using MIME encapsulation. The “high” and “low” button representations 444, 446 are typically used to rate the importance of reading the particular message for the recipients. The “flag” button representation 448 is typically used to alert the recipient(s) that the message requires some sort of action on their part. Typically, upon selecting the “flag” button representation 448, the e-mail client prompts the user to define what kind of action is required of the recipient(s). The “options” button representation 450 typically includes such options as voting buttons, delivery receipts, sensitivity, and expiration time, among others.

A new feature in one embodiment, among others, of the e-mail client is a “protect” button representation 452. The “protect” button representation 452 is operable to protect the message against subsequent alteration by the recipient(s) of the message. Upon sensing a user has selected the “protect” button representation 452, the e-mail client can convert the message into a format whereby the text of the message is protected from alteration. Such formats can include portable document format (PDF), graphics image format (GIF), joint photographic experts group (JPEG), and tag image file format (TIFF), among others. These file formats will inhibit the recipients (including recipients of the original message, and recipients of any forwarded message including the original text) from forwarding or replying to the message while altering the text of the message without the consent of the originator of the message.

The inclusion of the message can occur in many ways. The most common way to include the file currently would be as an attachment which appears as an icon at the bottom of the message. However, one skilled in the art should note that some files may be attached to the document as inline attachments according to the sending and/or receiving e-mail clients.

The write window 400 also includes a “To . . . ” field representation 454, which allows users to type in the e-mail addresses of the recipients of the e-mail. Alternatively, the user could select the “To . . ” button representation 456 and choose the e-mail addresses of the recipients from an address book. Similarly, the write window 400 typically includes a “Cc . . . ” field representation 458 and a “Cc . . . ” button representation 460 which allow the user to add “carbon copy” recipients to the message. The write window 400 also typically includes a “Subject” field representation 462 allowing the user to include a subject of the message in the header of the e-mail message. The write window 400 typically concludes with a message editor pane 464 which allows the user to create and edit the text of a message prior to sending the message.

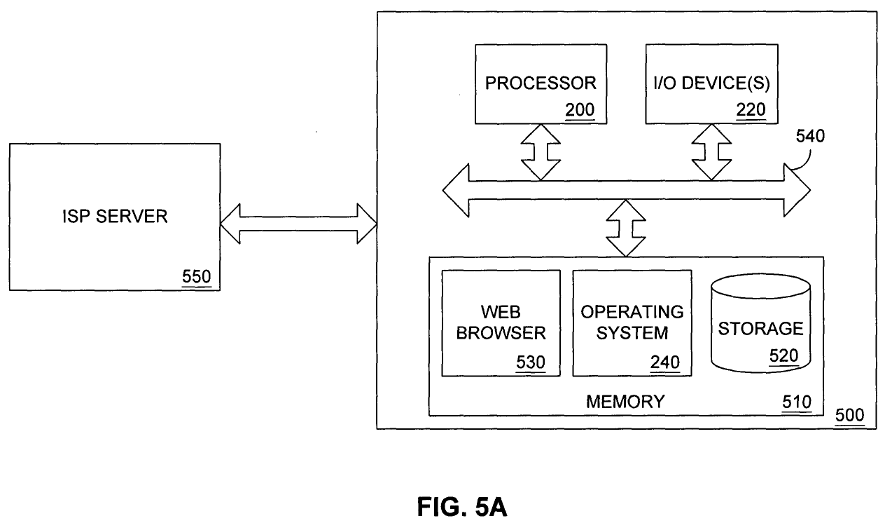

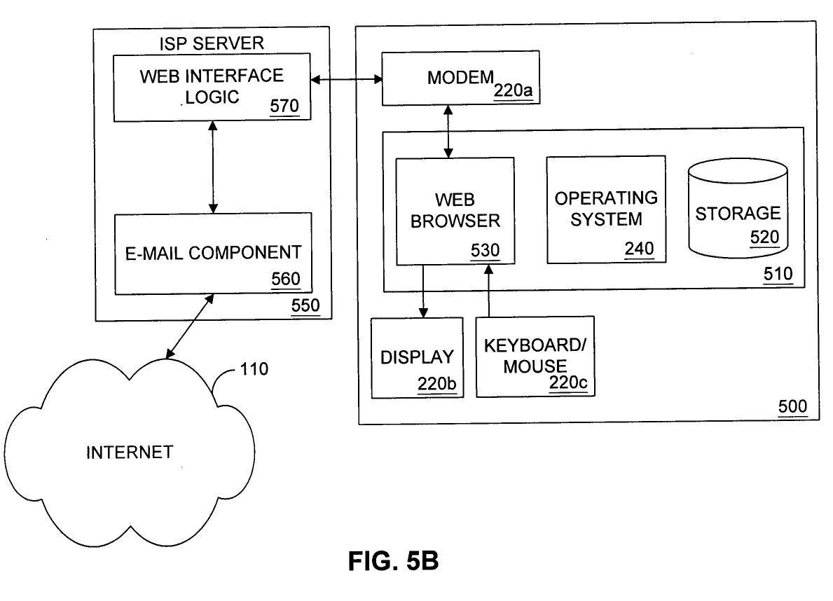

Referring now to FIG. 5A, shown is an alternative embodiment, among others, of a system that can be used in conjunction with the e-mail security system. As explained with reference to FIG. 2A, a computer system 500 typically includes a processor 200, memory 500 and input/output (I/O) device(s) 220, all communicating over a bus 230. The memory 510 typically includes the operating system 240 and non-volatile storage 520. The operating system 240 is typically stored in non-volatile memory while the computer 500 is turned off, and loaded into volatile memory upon start-up, where it can be executed by the processor 200. In the present embodiment, the memory further includes a web browser 530 which enables the computer 500 to send web page requests and receive web data to/from the ISP server 550 through an I/O device 220 such as an analog modem, DSL modem, ISDN modem or ethernet card, among others. Many ISPs now offer web-based e-mail solutions to their subscribers. To do so, the ISP server 550 typically includes an e-mail component and a web interface for user access.

Referring now to FIG. 5B, shown is a more detailed diagram of the system of FIG. 5A. As mentioned above, the ISP server 550 includes an e-mail component 560. As one skilled in the art will recognize the e-mail component 560 could include POP3, SMTP or IMAP4 components to retrieve messages from outside e-mail accounts. The e-mail component 560 in this embodiment typically receives messages for the user and stores the messages until the user requests them. Upon a user logging in and requesting e-mail, the web interface logic 570 can retrieve the stored messages for the user, format the web interface, and send the stored messages to the user. Moreover, as one skilled in the art should recognize, the web interface logic 570 could allow the user to set a plethora of viewing and interactive preferences.

Upon receiving the web e-mail data from the web interface logic 570 via the modem 220a, the web browser 530 is operable to communicate with the processor to display the web page on the display 220b. Moreover, the keyboard/mouse I/O device 220c is operable to select hyperlinks within the web page in order to view a page associated with the hyperlink. Typically, when a user wishes to view a message, the user selects a hyperlink associated with an e-mail message. Upon sensing the selection from the user, the web browser will request from the web interface logic 570. The web interface logic 570 can then retrieve details of the message and send a new web page to the user, including the details of the message. The web browser 530 receives the new web page through the modem 220a, and communicates with the processor to display the new web page on the display. The user may also compose messages via the web interface logic 570, typically by selecting a hyperlink to compose a message.

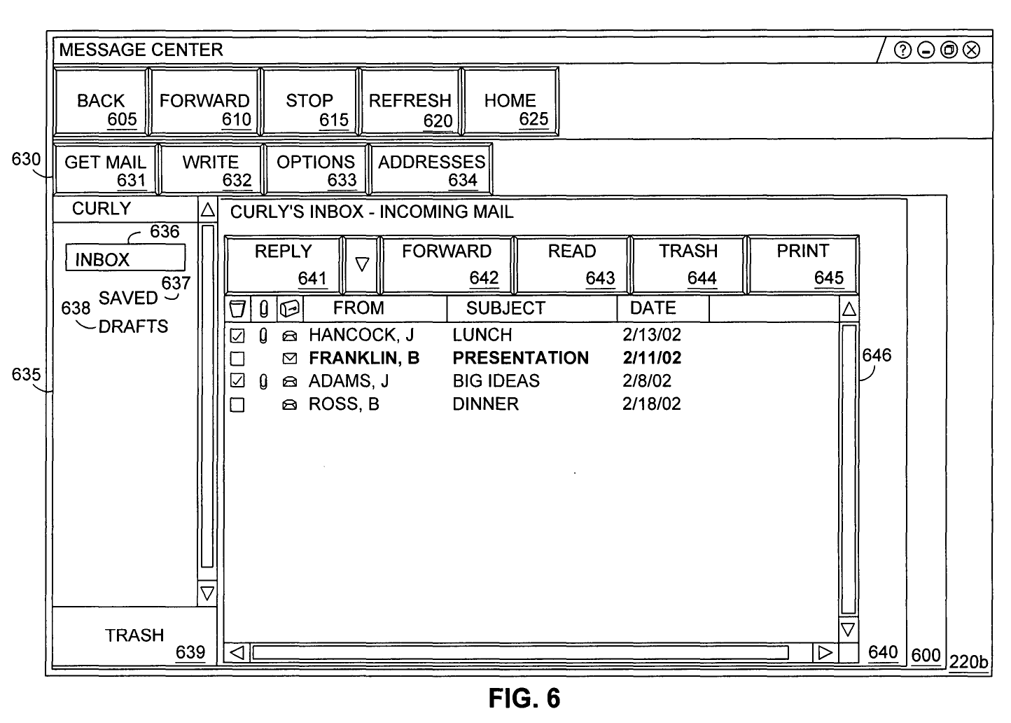

Referring now to FIG. 6, shown is an embodiment, among others, of a web e-mail message center screen shot that can be used with the system of FIGS. 5A and 5B. The web browser display 600 typically includes a number of command button representations, including, among others: a “Back” button representation 605, a “Forward” button representation 610, a “Stop” button representation 615, a “Refresh” button representation 620, and a “Home” button representation 625. The message center page typically includes many of the same attributes as the e-mail client of FIGS. 3 and 4. One skilled in the art will immediately recognize the options menu pane 630, the mailbox tree 635, and the message summary pane 640.

The options menu pane 630 includes a number of option button representations are selectable by the user with a mouse/keyboard 220c. These option button representations can include, among others, a “Get Mail” button representation 631, a “Write” button representation 632, an “Options” button representation 633, and a “Addresses” button representation 634. The “Get Mail” button representation 631 operates to instruct the web browser 530 to essentially refresh the page with any new mail that might now reside at the ISP 550. The “Write” button representation 632 operates to instruct the web browser to request a compose message web page from the ISP 120. Upon receiving the request for the compose message web page, the ISP 550 and the e-mail component 560 send the compose message web page back to the computer 500. The “Options” button representation 633 typically operates to request an options web page from the ISP 550. Upon receiving the request, the ISP 550, in conjunction with the web interface sends an options web page to the computer 500. The “Addresses” button representation 634 is typically operable to instruct the web browser 530 to request an address book web page associated with the current user from the ISP 550. The ISP 550, in conjunction with the web interface logic 570 and e-mail component 560, will return the address book web page associated with the user to the computer 500.

With respect to the mailbox tree 635, the user is typically allowed to choose between a plurality of folders located under the mailbox tree by selecting from a plurality of folder representations. These folder representations can include, among others, an “Inbox” folder representation 636, a “Saved” folder representation 637, a “Drafts” folder representation 638, and a “Trash” folder representation 639. The “Inbox” folder representation 636 typically represents a folder where incoming mail is originally stored. The “Saved” folder 637 typically represents a folder that the user can use to save important messages. The “Drafts” folder representation 638 typically represents a folder where incomplete drafts of a message can be stored until sent. The “Trash” folder representation 639 typically represents a folder where messages that the user has selected to delete are stored prior to permanent deletion. Permanent deletion can take place periodically, or by user request. One skilled in the art should recognize that there may (and often does) exist subfolders underneath each of the folders. In particular, the “Saved” folder can often contain subfolders which subdivide categories of messages, such as, for example, work and personal.

With regard to the message summary pane 640, the messages from the folder corresponding to the currently highlighted folder representation (the “Inbox” folder representation 636, in this example) are typically displayed for the user to peruse. The message summary pane 640 typically includes a plurality of action button representations, including, among others, a “Reply” button representation 641, a “Forward” button representation 642, a “Read” button representation 643, a “Trash” button representation 644, and a “Print” button representation 645. The “Reply” button representation 641 and “Forward” button representation, when selected, will request a compose message web page from the ISP 550. The ISP 550, in response, will typically return the compose message web page with a number of the fields pre-populated, in accordance with the function selected, the highlighted message and pre-defined user preferences. Upon selecting the “Read” button representation, the web browser will request that the ISP retrieve the currently checked message(s) to be displayed in detail. The “Trash” button representation 645 typically operates to allow the user to dispose of the currently checked message(s). Upon selecting the “Trash” button representation 645, the web browser 530 will instruct the ISP server 550 to place the message into the “Trash” folder, and refresh the message center web page without the deleted message. The message summary pane 640 also typically includes a message header representation 646 where each of the message headers of the messages in the currently selected message folder are displayed. A user can check any of the messages by clicking on the box to the left of the header.

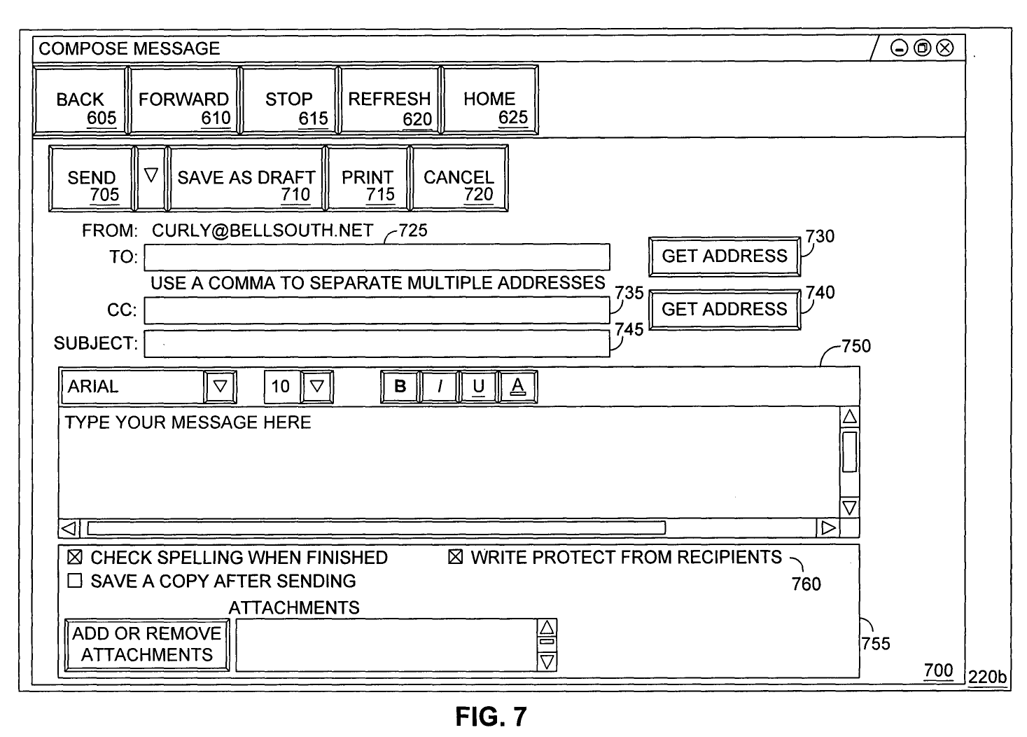

Referring now to FIG. 7, shown is an illustration of an embodiment, among others, of a compose message web page screen shot of the system of FIGS. 5A and 5B. The compose message web page 700 typically includes a plurality of button representations which send various instructions to the ISP 550, when selected by the user. These button representations can include, among others, a “Send” button representation 705, a “Save as Draft” button representation 710, a “Print” button representation 715, and a “Cancel” button representation 720. The “Send” button representation 705 typically operates to instruct the ISP, through the web browser, to send the message to the recipients indicated. The “Save as Draft” button representation 710 typically operates to save the message in the Draft folder discussed above. The “Print” button representation 715 typically operates to send the message to the printer to be printed. The “Cancel” button representation 720 typically operates to cancel the current message and return to the message center web page 600.

The compose message web page 700 also typically includes a header information section. In the header information section, the user can typically enter the recipients of the message into the “To . . . ” field representation 725, or by clicking the “Get Address” button representation 730 to open an address book associated with the user. Similarly, the user can typically ‘copy’ the message to other recipients by using the “Cc . . . ” field representation 735, or by clicking the “Get Address” button representation 740 to open the address book associated with the user. The user may also enter a subject for the message into the “Subject” field representation 745.

Another typical feature of the compose message web page 700 is the message editor pane 750. The message editor pane 750 allows a user to edit the text of his or her message prior to sending the message. One skilled in the art should also recognize that the user may be allowed to specify font type, font size, and other text characteristics. Furthermore, the compose message web page 700 can include a message options pane 755 which allows the user to select among several options that are to be performed with the message. These typically include a spell check, attachments, and saving a copy in a sent message folder, among others. In this embodiment, among others, of the present invention, the message options pane 755 also includes an write protect option 760 to write protect the message from recipients. This will request that the ISP 550 convert the message into a format that is more protected from alteration. Similar to before, some formats, among others, that can be used are PDF, GIF, JPEG and TIFF. Thus, the sender can be more confident that the message has some protection from mistakes or fraudulent retransmission.

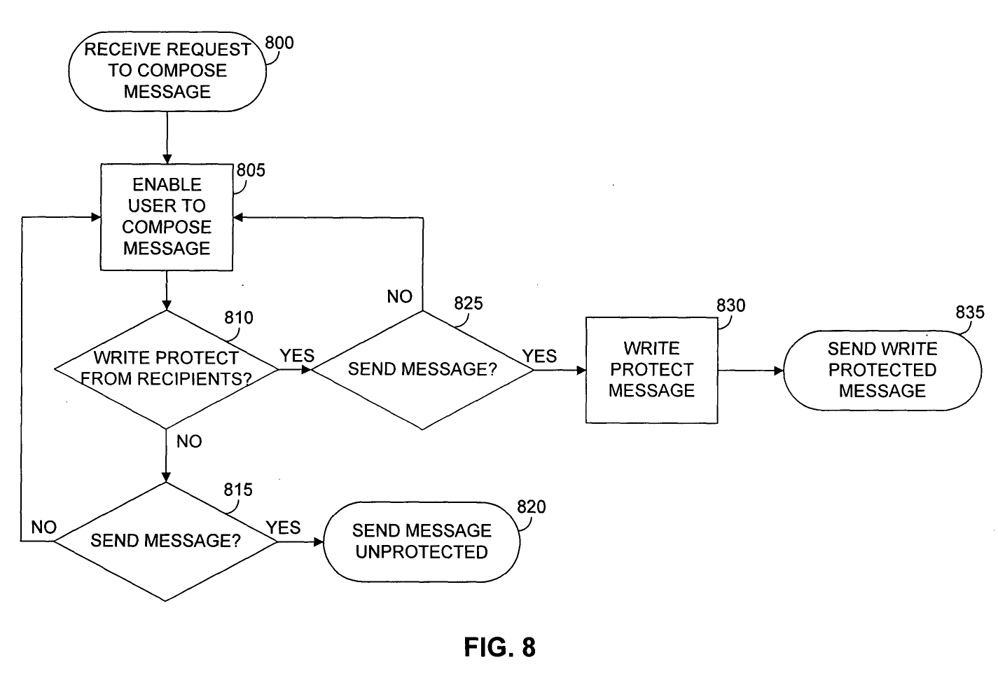

Referring now to FIG. 8, shown is a flowchart illustrating operation of the e-mail client 260 of FIGS. 2A and 2B, and the e-mail component 560 of FIGS. 5A and 5B. In step 800, the e-mail system receives a request to compose a message. The request to compose a message could be a request to compose a new message, or a reply to a previously received message or forward of a previously received message. In step 805, the e-mail system enables the user to compose a message. In the case of a new message, none of the fields will be pre-populated with recipient and or message text. However, in the case of a reply message, the “To . . . ” field representation 725, and possibly the “Cc . . . ” field representation, along with the “Subject” field representation 745 and message editor pane 750 are typically pre-populated based on the previously received message to which the user is replying. One skilled in the art should recognize that some e-mail systems do not pre-populate the original text in the message editor pane 750, or allow the user to specify a preference, and that these systems are intended to be included within the scope of the present invention. Similarly, in the case of a forwarded message, the “Subject” field representation 745 and the message editor pane 750 are typically pre-populated; the “To . . . ” field representation 725 being left for the user to populate.

Typically, either during or after the user has edited his or her message, the user is allowed to choose among several options to apply to the message. In one embodiment, among others, of the present invention, the user is allowed to choose whether to write protect the message from the recipients, as shown in step 810. One skilled in the art should recognize that this option could be presented to the user at any time. One could even choose to write protect the message prior to even choosing to write the message by including a write protect setup option within the e-mail system, such that all outbound messages are write protected. If the user chooses not to write protect the message, the e-mail system checks to determine whether the user has chosen to send the message in step 815. If the user chooses to send the message, the e-mail system sends the message in accordance with step 820. However, if the user has not chosen to send the message, the process returns to step 805, and the user continues editing the message until he or she write protects the message or sends the message.

If the user, in step 810 chooses to write protect the message, the e-mail system will determine whether the user has instructed the e-mail system to send the message, as shown in step 825. If the e-mail system has been instructed to send the message, the system write protects the message as shown in step 830. The e-mail system then sends the write protected message to the appropriate server associated with the recipient(s). If the user has not selected to send the e-mail yet, the e-mail system allows the user to continue editing the message in step 805, waiting for the user to select both write protect and send, or to select not to write protect and send.

Process and function descriptions and blocks in flow charts can be understood as representing, in some embodiments, modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention. In addition, such functional elements can be implemented as logic embodied in hardware, software, firmware, or a combination thereof, among others. In some embodiments involving software implementations, such software comprises an ordered listing of executable instructions for implementing logical functions and can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a computer-readable medium can be any means that can contain, store, communicate, propagate, or transport the software for use by or in connection with the instruction execution system, apparatus, or device.

It should be emphasized that the above-described embodiments of the present invention are merely possible examples of implementations set forth for a clear understanding of the principles of the invention. Many variations and modifications may be made to the above-described embodiment(s) of the invention without departing substantially from the principles of the invention. All such modifications and variations are intended to be included herein within the scope of this disclosure and the present invention and protected by the following claims.

1. An e-mail client, comprising:
message composition logic operable to compose a message to at least one recipient;
write protect logic operable to protect the message against subsequent alteration by said at least one recipient.

2. The client of claim 1, wherein the write protect logic comprises conversion logic operable to change the file from a text file to a picture file.

3. The client of claim 2, wherein the picture file is included as an inline image within the message.

4. The client of claim 2, wherein the picture file is stored on a central server for retrieval by the recipient.

5. The client of claim 2, wherein the picture file is included as an attachment to the message.

6. The client of claim 2, wherein the picture file is a joint photographic experts group (JPEG) file.

7. The client of claim 2, wherein the picture file is a graphics image format (GIF) file.

8. The client of claim 1, wherein the write protect logic comprises conversion logic operable to change the file from a text file to a portable document format (PDF) file.

9. The client of claim 1, wherein the composition logic is operable to allow the user to compose a new message, a reply to a received message or forward a received message.

10. The client of claim 1, wherein the client further comprises a user interface operable to allow the user to select a plurality of options, including enabling the write protect logic.

11. A method of protecting e-mail, the method comprising the steps of:
enabling a user to draft a message; and
converting the message into a write-protected format such that recipients are inhibited from altering the content.

12. The method of claim 11, wherein the write-protected format comprises a portable document format (PDF) file.

13. The method of claim 11, wherein the write-protected format comprises a graphics image format (GIF) file.

14. The method of claim 11, wherein the write-protected format comprises a joint photographic experts group (JPEG) file.

15. The method of claim 11, the method further comprising:
enabling the user to choose whether to protect the message or not;
wherein converting the message into a write-protected format is performed responsive to user choice.

16. The method of claim 11, wherein the method further comprises sending the message to at least one recipient in the write-protected format.

17. The method of claim 16, wherein the message is stored on a central server for viewing by the user.

18. The method of claim 16, wherein the message is downloaded to a computer for viewing by the user.

19. The method of claim 16, wherein the message is included as an inline image file.

20. The method of claim 16, wherein the message is included as an attachment.
